(19) United States
(12) Patent Application Publication
(10) Pub. No.: US 2003/0110864 A1
(43) Pub. Date: Jun. 19, 2003

(54) Differential-pressure measuring cell

(76) Inventors: Aleksandar Vujanic, Vienna (AT); Dusan Vujanic, Silas-Laslovo (HR)

Correspondence Address: CHAPMAN AND CUTLER, 111 WEST MONROE STREET, CHICAGO, IL, 60603, US

(21) Appl. No.: 10/221,473

(22) PCT Filed: Mar. 12, 2001
(86) PCT No.: PCT/AT01/00068

(30) Foreign Application Priority Data
Mar. 14, 2000 (AT) GM 185/2000

(51) Int. Cl. G01L 13/02

(52) U.S. Cl. 73/716

(57) ABSTRACT

A differential pressure measuring cell comprising a measuring membrane (7) which can be impinged on both sides by a fluid, said fluid coming into contact with each side of the measuring membrane (7) via a respective measuring connection (2, 17), a respective additional deformable auxiliary membrane (4, 16) being allocated to both sides of the measuring membrane (7) and each side of said auxiliary membrane that faces a measuring connection (2, 17) being in open contact with the measuring membrane (7) and having a sealing surface (23, 24) which can be deformed during the deformation of the auxiliary membrane (4, 16) to lie against the measuring connection (2, 17) in a sealing manner. The measuring membrane (7) and the auxiliary membranes (4, 16) are configured as structured layers of a chip and consist substantially of Si or polysilicon and/or glass.

The invention relates to a differential pressure measuring cell comprising a measuring membrane which can be impinged on both sides by a fluid with said fluid coming into contact with each side of the measuring membrane via a respective measuring connection.

European patent EP 167 941 discloses a differential pressure measuring cell with a semiconductor measuring membrane in which the measuring membrane has sealing surfaces which press against the pressure lines when a certain predetermined differential pressure is exceeded and in this manner close the lines. The pressure supply line runs into a ring groove in the housing. The measuring membrane itself is formed into a center area that acts as the measuring membrane and into an enlargement that surrounds the measuring membrane and on which sealing surfaces for the respective other pressure line are formed with the pressure line in turn running into ring grooves. In this case the actual measuring membrane is restricted to a small partial area of a mobile wall that ensures the corresponding lift that is required for closing the respective pressure supply lines. The outside portion of this mobile wall whose center area forms the measuring membrane, is correspondingly more flexible and the center area that forms the measuring membrane has a correspondingly thicker wall thickness in order to prevent any inadmissible deformations or damage to the central area in which resistance measuring strips are arranged, for example. However, such an embodiment requires a minimum thickness of the measuring membrane which, in case the membrane closes and at the time immediately before the closing, must absorb the full differential pressure on that side on which the annular enlargements are arranged. This means that this membrane is subject to impact-type stress, which could be accompanied by inadmissible deformations. In principle the mobile wall acts like a check valve and provides overstress protection itself which means it is subject to high impact forces during the closing process due to overstress.

Conventional differential pressure measuring cells have been equipped with additional membranes that provide overstress protection. However, such conventional devices require extensive assembly.

The object of the invention is to provide a differential pressure measuring cell in which highly sensitive semiconductor measuring membranes can be used which simultaneously provide the known function of overstress protection with minimal manufacturing and assembly efforts. The object of the invention is attained in that the embodiment of the differential pressure measuring cell in accordance with the invention is substantially comprised of both sides of the measuring membrane being allocated an additional deformable auxiliary membrane with each side of said auxiliary membrane that faces a measuring connection being in open contact with the measuring membrane and the side facing the measuring connection and having a sealing surface which can be deformed during the deformation of the auxiliary membrane lying against the measuring connection in a sealing manner and in that the measuring membrane and the auxiliary membranes are configured as structured layers of a chip and consist substantially of Si or polysilicon and/or glass. Due to the fact that there are not only measuring membranes but also auxiliary membranes, the measuring membrane can be protected against excessive impact in cases of overstress, i.e. inadmissibly high differential pressure. Due to the fact that the measuring membrane and the auxiliary membranes are made of structured layers of a chip, an embodiment is created that can easily and inexpensively be produced based on a micro-mechanical process. Due to the fact that the side facing a measuring connection is in open contact with the measuring membrane and due to the fact that only the auxiliary membrane has a sealing surface on the side that is allocated to the measuring connection, only the auxiliary membrane is subject to impact stress during closing which means that such impact stress can be kept away from the measuring membrane and is absorbed by the auxiliary membranes. Overall such an embodiment is easily obtained based only on micro-mechanical processes so that the impact stress only acts slightly on the measuring membrane during closing. In an advantageous manner the embodiment is such that the measuring membranes are connected in a sealing manner on diametrically opposed sides to the respective adjacent auxiliary membrane in a point that is opposite the fixing point of the auxiliary membrane with spacer elements being arranged between them. Based on the respective sensitivity requirements, the measuring membrane can either be large and/or thin and can carry a corresponding number of sensors, especially integrated piezo-resistors or capacitive measuring cells which increase the sensitivity significantly since the arrangement and the design of the measuring membrane itself is not subject to any restrictions whatsoever, which must be expected with arrangements of sealing surfaces on the measuring membrane. This means the desired structure can be obtained in a very simple manner based on the desired degree of sensitivity using micro-mechanical processes and without having to take the type and arrangement of the pressure supply line into consideration.

In an especially advantageous manner the embodiment is such that the structure comprised of membranes and spacer elements is monolithic. It is possible to use micro-mechanical process technologies for the micro-mechanical machining of the structure of individual, stacked wafer plates. The wafers subsequently only must be connected to each other accordingly which again can be accomplished by simply gluing or bonding them with conventional methods. In this manner the mechanical structure is much simpler since even multi-layer designs are much easier to produce using micro-mechanical processes than mechanically assembling discrete, separate components. The required elasticity can be adjusted by using simple etching steps with a high degree of precision and due to the selected structure it is possible to ensure a high degree of elasticity without overstressing any of the membranes, which above all is especially simple due to the fact that the measuring membrane can be moved in opposite direction to the auxiliary membranes.

Without affecting the precision and the properties of the measuring membranes it is possible, according to the invention and according to a preferred embodiment, that the areas of the auxiliary membranes adjacent to the sealing surfaces have a smaller thickness or a more elastic structure that can be impinged on by pressure in the direction of a separation of the sealing surfaces after closing. This means that for elasticity purposes the auxiliary membranes, which must take over the sealing function in case of overstress, can have any thickness or corresponding structures for any size areas without having to take the geometry of the measuring membrane into consideration which is necessary for a precise measuring process. The embodiment advantageously is such that the edges of the membranes are bonded via spacer elements made of Si or glass and wherein said sealing surfaces of the auxiliary membranes advantageously consist of polysilicon or Si or polished glass.

In principle such differential pressure measuring cells as a rule have a capsule design and have corresponding blocking membranes on their outside so that the measuring cell and the auxiliary membranes can be filled with an incompressible fluid. The pressure that is to be measured acts on the blocking membranes and the pressure difference acts on the measuring membrane via the transmission fluid that is contained on the inside of the measuring cell. To this end the embodiment advantageously is such that the hollow spaces of the multiple-layer chip are filled with a transmission fluid, in particular oil, and in that the measuring connections of the chip are sealed with an elastic sealing membrane with regard to the transmission fluid.

Using the embodiment in accordance with the invention it is possible for the arrangement to be advantageously such that the auxiliary membranes close the measuring connection with the lower pressure when a maximum pressure difference is exceeded. Since it is possible to easily realize a correspondingly large connection due to the design of the sealing surfaces on the auxiliary membranes, there could be adherence following the closing of the corresponding side with the lower pressure which is especially to be expected in the case of precision machined, highly-polished sealing surfaces. In order to ensure a subsequent clear separation in these cases, the embodiment advantageously is such that the wall areas of the measuring cell that are adjacent to the sealing surfaces have a thinner wall and can be impinged on by pressure fluid or that the sealing surfaces of the auxiliary membranes and/or the opposite surfaces adjacent to the measuring connections are piezo-vibrators and can be connected to a power source to generate a vibration that supports the opening movement so that it is possible to not only close the respective connection safely and tightly but also to obtain a subsequent and secure separation.

In order for a corresponding, throttled supply of the pressure differences to act on the measuring membrane itself, the embodiment advantageously is such that the channels that connect the respective measuring connection with one side of the measuring membrane have a conical cross-section that tapers off in the direction of the measuring membrane.

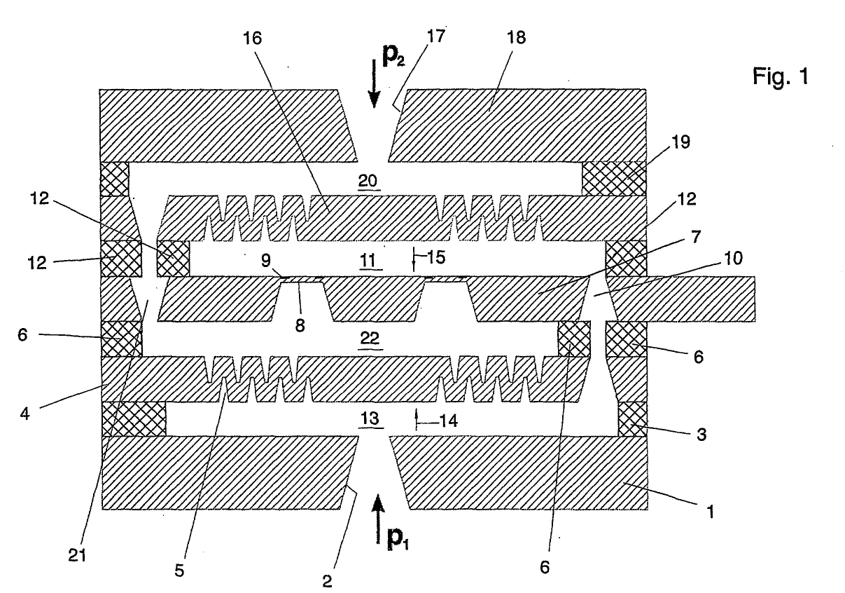

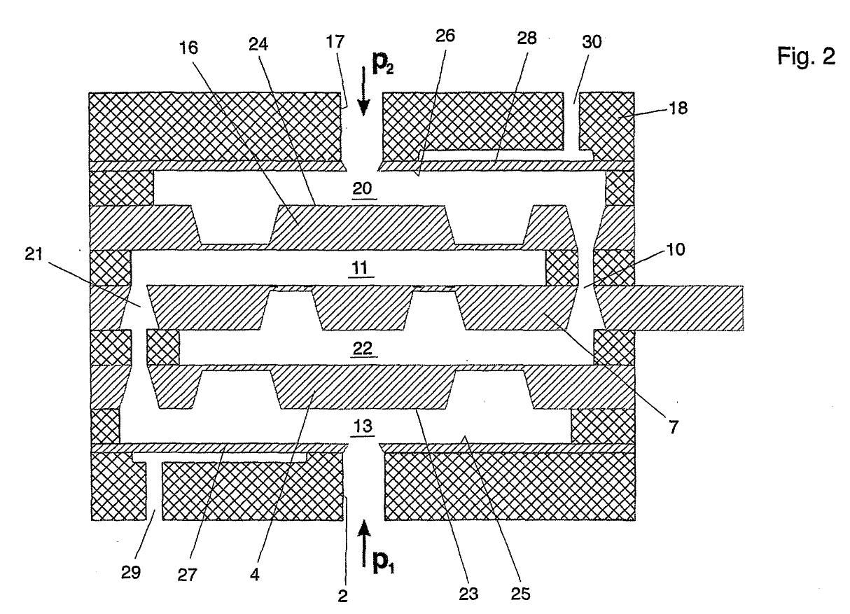

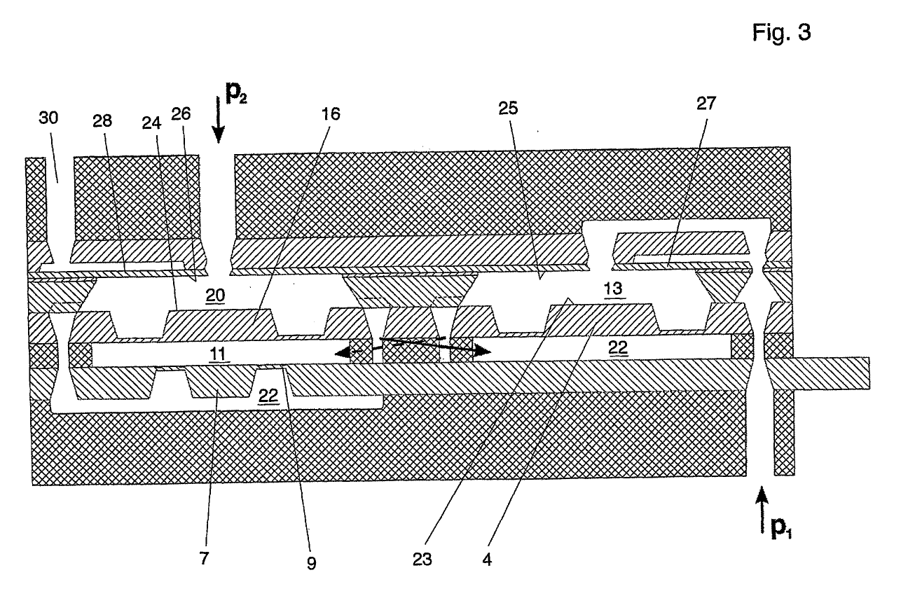

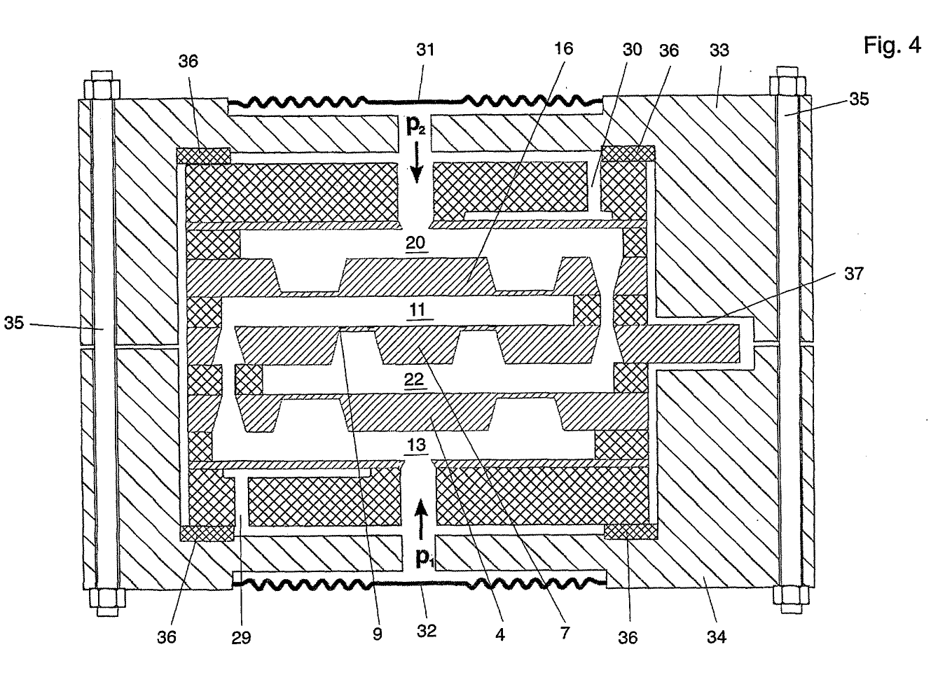

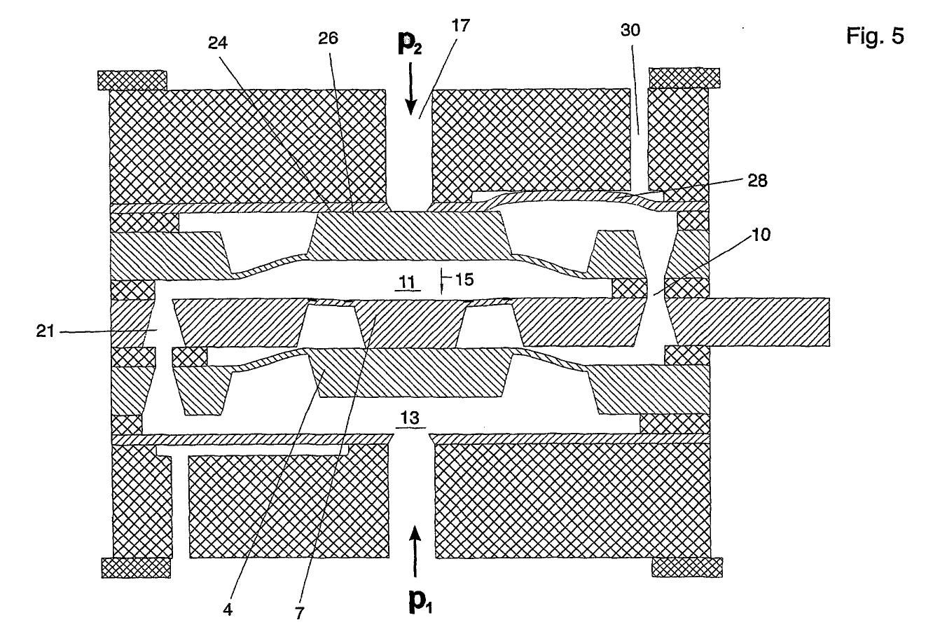

In the following paragraphs the invention is described in more detail based on the exemplary embodiments that are schematically rendered in the drawing. FIG. 1 shows a schematic sectional drawing of a first embodiment of the semiconductor-measuring cell. FIG. 2 shows another, slightly different embodiment. FIG. 3 shows a different embodiment in which the number of the layers used is reduced. FIG. 4 shows a completely assembled differential pressure measuring cell with capsule design and FIG. 5 shows a schematic view of the relative layers of the membrane when a given, maximum pressure difference is exceeded.

FIG. 1 discloses a multi-layer structure of a measuring cell in which a number of wafers are machined and stacked using a micro-mechanical process, especially etching. Based on a first silicon or glass wafer 1 in which the inlet opening 2 is arranged for a pressure connection or measuring connection, a first auxiliary membrane made of silicon 4 is structured with a spacer made of glass or silicon wafer 3 arranged in-between. For forming elastically deformable areas, a meandering structuring 5 is provided which allows for the elastic deformation of the auxiliary membrane 4. Within the layer structure there is another glass or Si wafer layer 6 which in turn again serves as a spacer element and wherein a free end of the auxiliary membrane 5 simultaneously is bonded with a free end of the measuring membrane 7 via such a spacer element 6. The actual measuring membrane is comprised of areas 8 based on the smaller cross-section and on which piezo-resistors 9 are arranged. A through channel 10 with tapering cross-sections for slowing the fluid flow is arranged laterally to the measuring membrane 7 as well as laterally to the first auxiliary membrane 5, with the channel turning into a closed chamber 11 on one side of the measuring membrane 7. The chamber, too, is limited by an arrangement of spacer elements 12 made of glass wafer wherein the chamber 11 has an open connection to the chamber 13 that is adjacent to pressure connection 2. An impinging on the chamber 13 and chamber 11 by pressure p1 results in a movement of the first auxiliary membrane in the direction of the arrow 14 and in an opposite movement of the measuring membrane 7 in the direction of arrow 15. The second auxiliary membrane 16 is connected via spacer elements 12 which again area made of glass or Si and again a connection 17 is arranged as a second measuring connection which is arranged in a silicon or glass wafer 18. In between spacer elements 19 are placed using micro-mechanical processes.

A pressure p2 that is applied via measuring connection 17, spreads across chamber 20 and the through-channels 21 into chamber 22 at the back side of the membrane so that here, too, an impinging by pressure p2 in principle results in an opposite movement of the auxiliary membrane 16 with regard to the measuring membrane 7.

In the presentation according to FIG. 2 the elastically deformable areas of the auxiliary membranes 4 and 16 are areas with small cross-section thickness so that here, too, an elastic deformation is possible whereby these areas can be sized based on the desired elasticity. The measuring membrane itself, which is identified with reference number 7 in FIG. 2 as well, can have the same design as in the embodiment according to FIG. 1 so that it is possible to set the respective, admissible high pressure differences with the help of the corresponding machining of auxiliary membranes 4 and 16.

The surfaces 23 and 24 that face the respective connections 2 and 17 and just like the respective opposite surfaces 25 and 26 are polished so that when the membranes 4 or 16 lie against these opposite surfaces 25 or 26, they do so in a sealing manner. In order to allow an opening when the two polished surfaces lie against each other providing the sealed closing, there are thin wall areas 27 and 28 in the area of the polished stopping faces 25 and 26 which can be impinged on by pressure via separate channels 29 and 30 in order to allow for a release of the auxiliary membranes 4 or 16.

In the embodiment according to FIG. 3 a correspondingly smaller number of layers is used and the respective membranes have the same reference numbers as are used in FIGS. 1 and 2. Here, too, the same kind of impingement of the membrane is possible in principle due to corresponding bores and the chamber 13 has an open connection to chamber 11 and chamber 20 has an open connection to chamber 22, which in turn allows an opposite movement of the measuring membrane 7 with regard to the movement of the respective auxiliary membranes 4 or 16. Since the two auxiliary membranes 4 and 16 are both in the same plane, it is possible to save a total of two levels which means the semiconductor sensor has an overall flatter design.

The drawing according to FIG. 4 shows the completely assembled differential pressure measuring cell in which outside cover membranes 31 and 32 are arranged in the housing parts 33 and 34 and the measuring cell itself is completely filled with incompressible fluid. This means the pressure is transferred to the fluid on the inside of the measuring cell with membranes 31 and 32 being arranged in-between and in this manner the differential pressure can be measured. Straining screws 35 connect the two housing parts 33 and 34 with seals 36 being arranged between the semiconductor components and the housing so that there is a sealed hollow space in which the electric contact can occur at 37.

FIG. 5 shows the shifting position of the individual membranes with a measuring sensor according to FIG. 2 or 4 in case of an inadmissibly high pressure difference. The polished surfaces 24 and 26 lie against each other in a sealing manner so that the measuring connection 17 is closed with the smaller pressure amount p2. In the process the measuring membrane 7 is shifted downward in the direction of arrow 15 since the pressure from the chamber 13 acts in chamber 11 via channel 21. Simultaneously the auxiliary membrane 4 can be made to lie against measuring membrane 7 so that the measuring membrane 7 cannot deform inadmissibly. In order to ensure that, based on such a position in which the maximum admissible pressure difference is exceeded, it is possible for the auxiliary membrane 16 to open, the pressure is not only impinged via connection 17 but simultaneously also via connection 30 on the wall area 28 so that this wall area is deformed with the deformation causing a separation or a diverging movement of the polished surfaces 24 and 26. A schematic cross-section of membranes 16, 7 and 4 shows that they are schematically lined up to form an S-shape so that a high degree of elasticity is guaranteed while the chances of a break are low. The polished surfaces directly form a highly effective check valve so that when an admissible pressure difference is exceeded, the membrane 7 closes and does not shift again.

1. A differential pressure measuring cell comprising a measuring membrane (7) which can be impinged on both sides by a fluid, said fluid coming into contact with each side of the measuring membrane (7) via respective measuring connections (2, 17), wherein a respective additional deformable auxiliary membrane (4, 16) being allocated to both sides of the measuring membrane (7) and each side of said auxiliary membrane that faces a measuring connection (2, 17) being in open contact with the measuring membrane (7) and having a sealing surface (23, 24) which can be deformed during the deformation of the auxiliary membrane (4, 16) to lie against the measuring connection (2, 17) in a sealing manner and the measuring membrane (7) and the auxiliary membranes (4, 16) being configured as structured layers of a chip and consisting substantially of Si or polysilicon and/or glass.

2. Differential pressure measuring cell according to claim 1, wherein said measuring membrane (7) is connected in a sealing manner at diametrically opposed sides to the respective adjacent auxiliary membrane (4, 16) in a point that is opposite the fixing point of the auxiliary membrane (4, 16) with spacer elements (6, 12) being arranged in-between them.

3. Differential pressure measuring cell according to claim 1 or 2, wherein said areas of the auxiliary membranes (4, 16) that are adjacent to the sealing surfaces (23, 24) have a small thickness or elastic structure which can be impinged on by pressure in the direction of a separation of the sealing surfaces (23, 24) after closing.

4. Differential pressure measuring cell according to claim 1, 2 or 3, wherein said membranes (4, 7, and 16) are bonded with each other along their edges with spacing elements (6, 12) made of Si or glass.

5. Differential pressure measuring cell according to one of the claims 1 through 4, wherein said sealing surfaces (23, 24) of the auxiliary membranes (4, 16) are made of polished polysilicon or Si or polished glass.

6. Differential pressure measuring cell according to one of the claims 1 through 5, wherein said hollow spaces (11, 13, 20, 22) of the multi-layer chip are filled with a transmission fluid, especially oil, and said measuring connections (2, 17) of the chip being sealed with an elastic sealing membrane (31, 32) with regard to the transmission fluid.

7. Differential pressure measuring cell according to one of the claims 1 through 6, wherein said auxiliary membranes (4, 16) are arranged in a manner that ensures that the measuring connection with the lower pressure is closed when a maximum pressure difference is exceeded.

8. Differential pressure measuring cell according to one of the claims 1 through 7, wherein said measuring membrane (7) can be impinged on in opposite movement with regard to the auxiliary membranes (4, 16) when the pressure difference increases.

9. Differential pressure measuring cell according to one of the claims 1 through 8, wherein said wall areas (27, 28) of the measuring cell that are adjacent to the sealing surfaces (23, 24) have thinner walls and can be impinged on by a pressure fluid.

10. Differential pressure measuring cell according to one of the claims 1 through 9, wherein said sealing surfaces (23, 24) of the auxiliary membranes (4, 16) and/or the opposite surfaces (25, 26) that are adjacent to the measuring connections, are piezo-vibrators and can be connected to a power source in order to produce a vibration that supports the opening movement.

11. Differential pressure measuring cell according to one of the claims 1 through 10, wherein said channels (10, 21) that connect the respective measuring connection (2, 17) with one side of the measuring membrane (4, 16) have a conical cross-section that tapers off in the direction of the measuring membrane (7).
